(19) United States
(12) Patent Application Publication
(10) Pub. No.: US 2013/0077652 A1
(43) Pub. Date: Mar. 28, 2013

(54) APPARATUS FOR MEASURING TEMPERATURE AND METHOD FOR MEASURING TEMPERATURE

(71) Applicant: SAMSUNG ELECTRO-MECHANICS CO., LTD., Gyunggi-do (KR)

(72) Inventor: Seung Chul Pyo, Gyeonggi-do (KR)

(73) Assignee: SAMSUNG ELECTRO-MECHANICS CO., LTD., Gyunggi-do (KR)

(21) Appl. No.: 13/624,774

(22) Filed: Sep. 21, 2012

(30) Foreign Application Priority Data
Sep. 23, 2011 (KR) 10-2011-0096499

(51) Int. Cl. G01K 7/16

(52) U.S. Cl. 374/183; 374/E07.018

(57) ABSTRACT

Disclosed herein are an apparatus for measuring temperature and a method for measuring temperature. The apparatus includes: a resistive type sensor having a resistor and sensing pressure or motion to output an electric signal; a sensor signal processor processing the signal outputted from the resistive type sensor to compute a value corresponding to pressure or motion; a temperature dependent frequency signal generator connected to the resistive type sensor, and generating a temperature dependent frequency signal by using current variation information according to the temperature variation of the resistive type sensor; and a temperature compensation signal generator processing the signal outputted from the temperature dependent frequency signal generator to output temperature variation information. The apparatus can sense inertia, pressure, or the like and measure the temperature at the same time, and thus, compactness and low power consumption of the apparatus for measuring various kinds of pressures or inertia can be realized.

### CROSS REFERENCE(S) TO RELATED APPLICATIONS

This application claims the benefit under 35 U.S.C. Section 119 of Korean Patent Application Ser. No. 10-2011-0096499, entitled “Apparatus for Measuring Temperature and Method for Measuring Temperature” filed on Sep. 23, 2011, which is hereby incorporated by reference in its entirety into this application.

### BACKGROUND OF THE INVENTION

1. Technical Field

The present invention relates to an apparatus for measuring temperature and a method for manufacturing temperature, and more particularly, to an apparatus for measuring temperature and a method for measuring temperature, according to which temperature variation is measured by using a frequency signal reflecting a current variation value according to the temperature variation of a resistive type sensor.

2. Description of the Related Art

Various types of inertial sensors sensing inertia related factors such as acceleration, angular velocity, or the like, and sensors sensing pressure, temperature, or the like have been developing.

Most of these sensors include resistors.

Meanwhile, the sensors employ methods of compensating for a difference between resultant values according to the temperature variation for precise measurement.

For example, as proposed in Patent Document 1, temperature compensation in a pressure sensor may be performed by using a temperature compensation resistor.

Meanwhile, the technology proposed in Patent Document 1 will be schematically simplified as shown in FIG. 1. In other words, a sensor for pressure measurement and a separate temperature sensor 20 for temperature compensation are used to compensate for a difference according to the temperature.

However, in a case where a separate sensor for temperature compensation is provided, as shown in Patent Document 1, there is a limit in reducing the sizes of apparatuses, and separate power for sensing and compensating for temperature needs to be consumed.

Reference Document

Patent Document 1: U.S. Pat. No. 6,101,883

### SUMMARY OF THE INVENTION

An object of the present invention is to provide an apparatus for measuring temperature and a method for measuring temperature, capable of sensing pressure and inertia and measuring temperature at the same time by using only a resistive type sensor.

According to one exemplary embodiment of the present invention, there is provided an apparatus for measuring temperature, including: a resistive type sensor having a resistor and sensing pressure or motion to output an electric signal; a sensor signal processor processing the signal outputted from the resistive type sensor to compute a value corresponding to pressure or motion; a temperature dependent frequency signal generator connected to the resistive type sensor, and generating a temperature dependent frequency signal by using current variation information according to the temperature variation of the resistive type sensor; and a temperature compensation signal generator processing the signal outputted from the temperature dependent frequency signal generator to output temperature variation information.

The apparatus may further include a reference frequency signal generator connected to the temperature compensation signal generator and supplying a reference frequency signal unrelated to the temperature variation, wherein the temperature compensation signal generator compares the signal outputted from the temperature dependent frequency signal generator with the reference frequency signal to output the temperature variation information.

The temperature dependent frequency signal generator may include: a driving power; a current mirror connected between the driving power and the resistive type sensor; and a ring oscillator connected to the current mirror.

The current mirror may mirror current flowing between the driving power and the resistive type sensor to supply the mirrored current as a first driving power of the ring oscillator.

According to another exemplary embodiment of the present invention, there is provided an apparatus for measuring temperature, including: a resistive type sensor; a first transistor having a first terminal connected to the resistive type sensor; at least one second transistor allowing the same current as the first transistor to flow therethrough; a driving power connected to second terminals of the first transistor and the second transistor; at least one first inverter having a driving power terminal connected to the first terminal of the second transistor; and a temperature compensation signal generator processing an output signal of the inverter to output temperature variation information in the resistive type sensor.

The apparatus may further include a reference frequency signal generator having at least one second inverter having a driving power terminal connected to a current source unrelated to temperature variation, wherein the temperature compensation signal generator compares a signal outputted from the first inverter with a signal outputted from the second inverter to output the temperature variation information in the resistive type sensor.

The numbers of the second transistor and the first inverter may be three, respectively, and the three first inverters may constitute a ring oscillator.

The numbers of the second transistor, the first inverter, and the second inverter may be three, respectively, and the three first inverters and three second inverters may constitute a ring oscillator.

The apparatus may further include a sensor signal processor processing the signal outputted from the resistive type sensor to compute a value corresponding to pressure or motion.

According to still another exemplary embodiment of the present invention, there is provided a method for measuring temperature, including: (A) generating a temperature dependent frequency signal by reflecting current variation according to the temperature variation of a resistive type sensor; and (B) computing the temperature dependent frequency signal to output a temperature compensation signal.

The step (A) may include generating the temperature dependent frequency signal by applying the current variation according to the temperature variation of the resistive type sensor to a ring oscillator.

The step (A) may include generating the temperature dependent frequency signal by mirroring the current variation according to the temperature variation of the resistive type sensor using a current mirror and applying the mirrored current variation to a ring oscillator.

The step (B) may include outputting the temperature compensation signal according to a temperature change by comparing the temperature dependent frequency signal with a reference frequency signal unrelated to temperature.

### BRIEF DESCRIPTION OF THE DRAWINGS

FIG. 1 is a block diagram schematically showing a sensor apparatus according to the related art;

FIG. 2 is a block diagram schematically showing an apparatus for measuring temperature according to one exemplary embodiment of the present invention;

FIG. 3 is a block diagram schematically showing a temperature dependent frequency signal generator according to the exemplary embodiment of the present invention;

FIG. 4 is a block diagram schematically showing a reference frequency signal generator according to the exemplary embodiment of the present invention; and

FIG. 5 is a block diagram schematically showing an apparatus for measuring temperature according to another exemplary embodiment of the present invention.

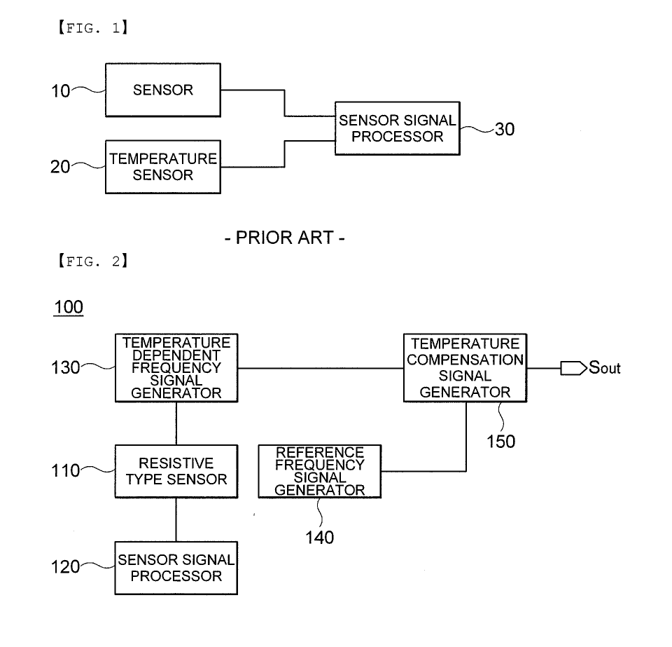

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the exemplary embodiments set forth herein. Rather, these exemplary embodiments may be provided so that this disclosure will be thorough and complete, and will fully convey the scope of the invention to those skilled in the art. Like reference numerals in the drawings denote like elements.

Terms used in the present specification are for explaining the exemplary embodiments rather than limiting the present invention. In the specification, a singular type may also be used as a plural type unless stated specifically. The word “comprise” and variations such as “comprises” or “comprising,” will be understood to imply the inclusion of stated constituents, steps, operations and/or elements but not the exclusion of any other constituents, steps, operations and/or elements.

Hereinafter, constitution and operating effects of the present invention will be described in more detail with reference to the accompanying drawings.

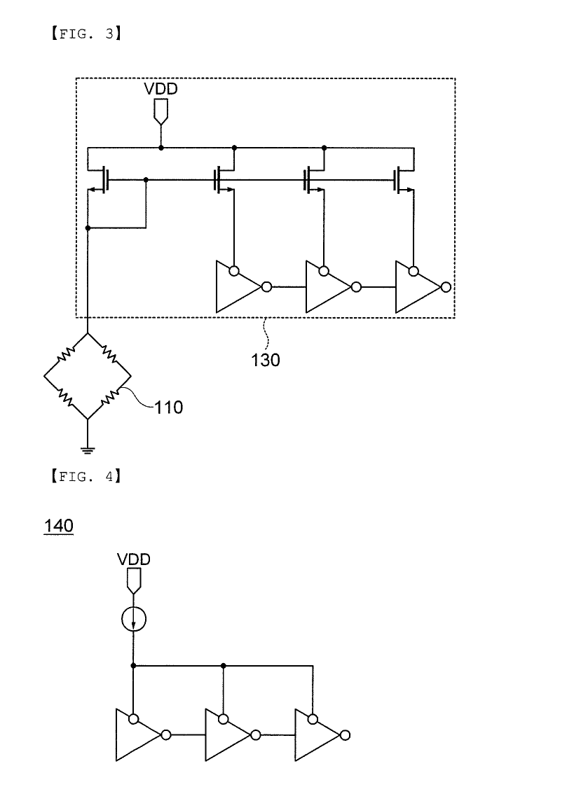

FIG. 2 is a block diagram schematically showing an apparatus 100 for measuring temperature according to one exemplary embodiment of the present invention.

Referring to FIG. 2, an apparatus 100 for measuring temperature according to one exemplary embodiment of the present invention may include a resistive type sensor 110, a temperature dependent frequency signal generator 130, and a temperature compensating signal generator 150.

The resistive type sensor 110 may be a common sensor device, which senses pressure or operation to output an electric signal.

Meanwhile, the resistive type sensor 110 may include a separate sensor signal process part 120 processing the signal outputted by sensing pressure or operation, and thereby to computing acceleration, inertia, or the like.

The temperature dependent frequency signal generator 130 generates signals of different frequencies by using a property of the resistive type sensor 110 in which temperature variation leads to variation in the resistance value, resulting in a current change.

FIG. 3 is a block diagram schematically showing the temperature dependent frequency signal generator 130 according to the exemplary embodiment of the present invention. Referring to FIG. 3, the temperature dependent frequency signal generator 130 may include a driving power VDD; a current mirror connected between the driving power VDD and the resistive type sensor 110; and a ring oscillator connected to the current mirror.

Specifically, the current mirror may consist of a first transistor M1 and three second transistors M11, M12, and M13, and the ring oscillator may consist of three first inverters INV1, INV2, and INV3.

The resistive type sensor 110 is connected to a first terminal of the first transistor M1, the driving power VDD is connected to a second terminal thereof, and a control terminal and the first terminal thereof are short circuited.

Further, respective control terminals of the three second transistors M11, M12, and M13 are connected to the control terminal of the first transistor M1, and respective second terminals of the second transistors M11, M12, and M13 are connected to the driving power VDD.

In addition, first terminals of the three second transistors M11, M12, and M13 are connected to driving power terminals of the three first inverters INV1, INV2, and INV3, respectively, and thereby to apply driving power.

The current of the first transistor M1 is varied according to the temperature variation of the resistive type sensor 110. Here, the current flowing through the first transistor M1 is mirrored by the second transistors M11, M12, and M13, and applied as the driving power VDD of the first inverters INV1, INV2, and INV3.

Further, a frequency of the signal outputted through the ring oscillator is determined by receiving this current reflecting the temperature variation of the resistive type sensor 110 as the driving power.

For this reason, the temperature dependent frequency signal generator 130 generates and outputs a frequency signal according to the temperature variation of the resistive type sensor 110.

Meanwhile, the resistive type sensor 110 is exemplified to have a bridge type in FIG. 3, but is not limited thereto.

The temperature compensation signal generator 150 may process the signal outputted from the temperature dependent frequency signal generator 130, and thereby to output temperature variation information. Here, the outputted information may be utilized to correct a measurement value of pressure or inertia of the resistive type sensor 110, and may be utilized as a separate temperature measurement tool.

Here, the temperature compensation signal generator 150 compares a difference in frequency between a predetermined reference frequency signal with the signal outputted from the temperature dependent frequency signal generator 130, and thereby to compute temperature variation.

Meanwhile, the apparatus 100 for measuring temperature according to the exemplary embodiment of the present invention may further include a separate reference frequency signal generator 140.

Contrary to the above-described temperature dependent frequency signal generator 130, the reference frequency signal generator 140 generates a frequency signal unrelated to temperature variation, and thereby to provide the signal to the temperature compensation signal generator 150.

The temperature compensation signal generator 150 compares between the reference frequency signal provided from the reference frequency signal generator 140 with the temperature dependent frequency signal provided from the temperature dependent frequency signal generator 130, and thereby to compute a temperature variation amount.

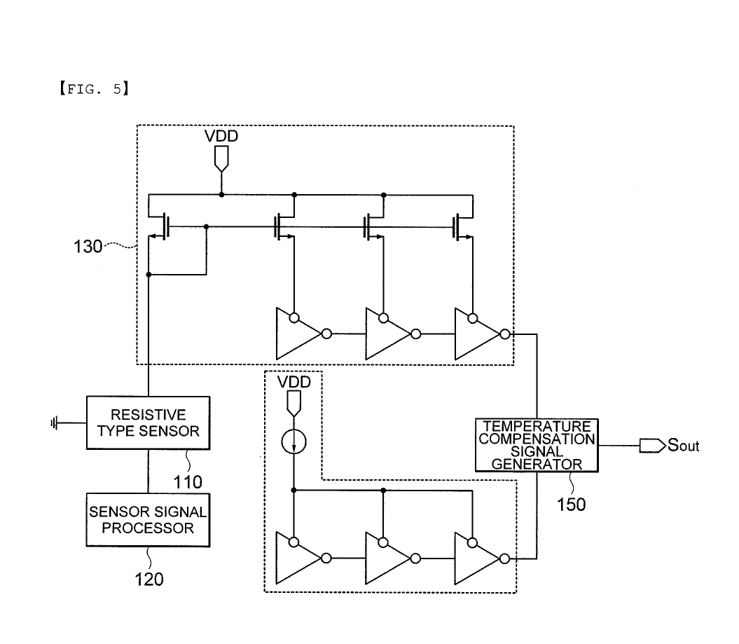

FIG. 4 is a block diagram schematically showing the reference frequency signal generator 140 according to the exemplary embodiment of the present invention.

Referring to FIG. 4, it can be understood that the reference frequency signal generator 140 may consist of three second inverters INV1′, INV2′, and INV3′ connected to the driving power terminal, of which driving power terminals are connected to a current source (Is) unrelated to temperature variation.

FIG. 5 is a block diagram schematically showing an apparatus 100 for measuring temperature according to one exemplary embodiment of the present invention.

Referring to FIG. 5, a sensor signal processor 120 is connected to one side of a resistive type sensor 110 to process information about inertia, pressure, or the like, and a temperature dependent frequency signal generator 130, which consists of a current mirror and a ring oscillator, is connected to the other side of the resistive type sensor 110 to generate a temperature dependent frequency signal of which a frequency is changed, by reflecting temperature variation information.

In addition, when a reference frequency signal unrelated to temperature variation, which is generated in the reference frequency signal generator 140, is supplied to the temperature compensation signal generator together with the temperature dependent frequency signal, the temperature compensation signal generator 150 computes a frequency difference between inputted two signals to output a temperature variation result, which can be then utilized for temperature measurement and temperature compensation.

A method for measuring temperature according to one exemplary embodiment of the present invention may include: reflecting current variation according to the temperature variation of a resistive type sensor to generate a temperature dependent frequency signal; and computing the temperature dependent frequency signal to output a temperature compensation signal.

Here, the generating of the temperature dependent frequency signal may be performed in a manner that current variation according to the temperature variation of the resistive type sensor 110 is applied to a ring oscillator and thereby to generate the temperature dependent frequency signal.

Further, the applying of the temperature variation according to the temperature variation to the ring oscillator may be performed in a manner that current variation according to the temperature variation of the resistive type sensor 110 is mirrored by using the current mirror and thereby to apply the mirrored current variation to the ring oscillator.

Further, the outputting of the temperature compensation signal may be performed in a manner that the temperature dependent frequency signal is compared with a reference frequency signal unrelated to temperature and thereby to output the temperature compensation signal according to the temperature change.

Accordingly, the method for measuring temperature according to the present exemplary embodiment of the present invention can sense inertia, pressure, or the like and measure the temperature at the same time, and thus, compactness and low power consumption of an apparatus for measuring various kinds of pressures or inertia can be realized.

The apparatus for measuring temperature and the method for measuring temperature according to the present invention as above can sense inertia, pressure, or the like, and measure the temperature at the same time, thereby providing advantageous effects that compactness and low power consumption of the apparatus can be realized.

The present invention has been described in connection with what is presently considered to be practical exemplary embodiments. Although the exemplary embodiments of the present invention have been described, the present invention may be also used in various other combinations, modifications and environments In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An apparatus for measuring temperature, comprising:
a resistive type sensor having a resistor and sensing pressure or motion to output an electric signal;
a sensor signal processor processing the signal outputted from the resistive type sensor to compute a value corresponding to pressure or motion;
a temperature dependent frequency signal generator connected to the resistive type sensor, and generating a temperature dependent frequency signal by using current variation information according to the temperature variation of the resistive type sensor; and
a temperature compensation signal generator processing the signal outputted from the temperature dependent frequency signal generator to output temperature variation information.

2. The apparatus according to claim 1, further comprising a reference frequency signal generator connected to the temperature compensation signal generator and supplying a reference frequency signal unrelated to the temperature variation, wherein the temperature compensation signal generator compares the signal outputted from the temperature dependent frequency signal generator with the reference frequency signal to output the temperature variation information.

3. The apparatus according to claim 1, wherein the temperature dependent frequency signal generator includes:
a driving power;
a current mirror connected between the driving power and the resistive type sensor; and
a ring oscillator connected to the current mirror.

4. The apparatus according to claim 3, wherein the current mirror mirrors current flowing between the driving power and the resistive type sensor to supply the mirrored current as a first driving power of the ring oscillator.

5. An apparatus for measuring temperature, comprising:
a resistive type sensor;
a first transistor having a first terminal connected to the resistive type sensor;
at least one second transistor allowing the same current as the first transistor to flow therethrough;
a driving power connected to second terminals of the first transistor and the second transistor;
at least one first inverter having a driving power terminal connected to the first terminal of the second transistor; and
a temperature compensation signal generator processing an output signal of the inverter to output temperature variation information in the resistive type sensor.

6. The apparatus according to claim 5, further comprising a reference frequency signal generator having at least one second inverter having a driving power terminal connected to a current source unrelated to temperature variation, wherein the temperature compensation signal generator compares a signal outputted from the first inverter with a signal outputted from the second inverter to output the temperature variation information in the resistive type sensor.

7. The apparatus according to claim 5, wherein the numbers of the second transistor and the first inverter are three, respectively, and the three first inverters constitute a ring oscillator.

8. The apparatus according to claim 6, wherein the numbers of the second transistor, the first inverter, and the second inverter are three, respectively, and the three first inverters and three second inverters constitute a ring oscillator.

9. The apparatus according to claim 5, further comprising a sensor signal processor processing the signal outputted from the resistive type sensor to compute a value corresponding to pressure or motion.

10. A method for measuring temperature, comprising:
(A) generating a temperature dependent frequency signal by reflecting current variation according to the temperature variation of a resistive type sensor; and
(B) computing the temperature dependent frequency signal to output a temperature compensation signal.

11. The method according to claim 10, wherein the step (A) includes generating the temperature dependent frequency signal by applying the current variation according to the temperature variation of the resistive type sensor to a ring oscillator.

12. The method according to claim 10, wherein the step (A) includes generating the temperature dependent frequency signal by mirroring the current variation according to the temperature variation of the resistive type sensor using a current mirror and applying the mirrored current variation to a ring oscillator.

13. The method according to claim 10, wherein the step (B) includes outputting the temperature compensation signal according to a temperature change by comparing the temperature dependent frequency signal with a reference frequency signal unrelated to temperature.
